(19) United States
(12) Patent Application Publication
(10) Pub. No.: US 2006/0170326 A1
(43) Pub. Date: Aug. 3, 2006

(54) Glass bulb for cathode ray tube

(75) Inventor: Toshihide Murakami, Takasago-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 11/319,072

(22) Filed: Dec. 28, 2005

(30) Foreign Application Priority Data
Dec. 28, 2004 (JP) 2004-381240

(51) Int. Cl. H01J 29/86; H01J 29/92

(52) U.S. Cl. 313/477 R

(57) ABSTRACT

A flat glass bulb for a cathode ray tube, which is light weight and provides good productivity, is realized.

The external shape of a cross section of a body portion 3 near the yoke portion, perpendicular to the bulb axis, is made to be a substantially rhombic shape or a substantially bobbin shape, the maximum diameter direction of the substantially rhombic cross section is made to be the same as the long axis direction of a funnel, maximum-diameter portions are provided between the long axis and diagonal axes when the cross sectional shape is the substantially bobbin shape, and the body portion is made to be constituted by a smooth continuous surface without having a step, a protrusion or recess, in which the minimum value of the differential value h=f(s) is made to be at least 0 provided that the distance from the yoke end in the direction perpendicular to the bulb axis is s, whereby the stress formed in the yoke portion is reduced to realize a flat cathode ray tube having high reliability.

### FIELD OF THE INVENTION

The present invention relates to a glass bulb for a cathode ray tube to be employed mainly for receivers of television broadcasting and industrial terminal devices.

### DISCUSSION OF BACKGROUND

In a cathode ray tube, as shown in FIG. 6, a vacuum envelope is basically constituted by a glass bulb consisting of a glass panel 1 for displaying an image and a glass funnel 2. The glass funnel 2 is constituted by a neck portion 5 accommodating an electron gun 6, a yoke portion 4 to which a deflection coil is attached, and a body portion 3 forming a portion from the yoke portion to the seal edge portion meeting the glass panel. In FIG. 6, a reference numeral 16 indicates a reinforcement band for maintaining the strength against shock, 10 indicates a sealing portion in which the glass panel 3 and the glass funnel 2 are sealed together with e.g. a solder glass, 12 indicates a phosphor film which emits fluorescence when it is irradiated with electron beam, 13 indicates an aluminum film to reflect fluorescence from the phosphor film forward, 14 indicates a shadow mask to define irradiation position on the phosphor with electron beam, 15 indicates a stud pin to fix a shadow mask 14 to an inner face of the glass panel 1, and 17 indicates an anode button to conduct and ground the shadow mask 14 to the outside to prevent high static charge of the shadow mask 14 by electron beams.

The anode button 17 is electrically conducted with the shadow mask via an internally coated graphite 9. Entire inner face of the funnel glass is covered with the internally coated graphite 9 and the internally coated graphite 9 serves to prevent external light from entering into the cathode ray tube, whereby the graphite serves to improve the contrast of an image. “A” indicates a tube axis connecting the center axis of the neck portion 5 and the center of the body portion 3, and B indicates a reference line of an imaginary reference line showing the center of deflection. A screen constituted by the phosphor film 12 formed on the inner face of the glass panel 1, has a substantially rectangular shape having a center at the tube axis A and constituted by four sides substantially in parallel with a long axis X or a short axis Y perpendicular to the tube axis.

In the cathode ray tube, inside of the glass bulb is maintained at high vacuum enabling to display an image by irradiation with an electron beam 11 in the glass bulb. Further, since 1 atm of a pressure difference between inside and outside is loaded to the glass bulb having an asymmetrical structure different from a spherical shell, the structure contains a high deformation energy and is in an unstable stress status. When a crack is formed in a glass bulb for cathode ray tube under such a state, the crack rapidly grows to release the high deformation energy contained, to lead to destruction of the glass bulb. Further, under a state that high stress is loaded to the external surface, moisture in the atmosphere reacts with the surface to produce delayed fracture, which deteriorates reliability.

In recent years, a large number of proposals of display devices other than cathode ray tubes, are made, and from the comparison with these devices, the depth of a cathode ray tube is pointed out as a serious disadvantage for a display device. For this reason, there is a trend to reduce the depth of cathode ray tubes. Specifically, developments target a flat glass funnel satisfying 3.2≦D/H provided that the diagonal length of the phosphor screen is D and the distance from the end of the diagonal line to the reference line of the glass funnel in a direction in parallel with the tube axis, is H. In such a structure, asymmetricity in the structure of the cathode ray tube is increased, and stress formed in the external surface further increases. In particular, increase of stress at the yoke portion is remarkable since deformation of body portion is concentrated on the yoke portion. The increase of the stress causes deterioration of safety due to destruction, and deterioration of reliability due to delayed fracture. Further, if glass thickness of the body portion is increased to prevent the increase of stress, the weight as another disadvantage of cathode ray tube significantly increase. Further, if the thickness of yoke portion is increased, such a serious problem that electron beam collides with inner face of the yoke portion to significantly deteriorate image quality, occur.

As a measure for such a problem, a method of providing a step shape or a protrusion in the body portion of glass funnel, has been known heretofore. For example, JP-A-2001-332190 discloses a method of providing a step 18 shown in FIG. 8 in the diagonal position of body portion, and WO03/34461 discloses a method of providing protrusions. Further, Japanese Patent No. 3383087 discloses a method of forming a recess 19 in a portion of body portion where the diameter of body portion gradually increases from the neck portion 5 through the yoke portion as shown in FIG. 7.

However, in the methods of providing steps or protrusions disclosed in JP-A-2001-332190 or WO03/34461, when a glass funnel is produced by press-molding a molten glass in a mold, unevenness in cooling the glass increases, which significantly deteriorates productivity. Namely, a portion such as “d” of FIG. 8 and FIG. 9 thicker than other portions, is inevitably formed, and cooling of such portion tends to be insufficient and the temperature in such a portion is higher than other portions. If the temperature is too high, deformation may be caused, and if the temperature difference is large, strain due to the difference in expansion causes crack. Further, the internal face of a funnel glass is coated with graphite in the production of cathode ray tube. If there is a step or a recess, the film thickness of the internally coated graphite 9 becomes uneven as shown in FIG. 8, which may cause exfoliation of the graphite. The reason of the unevenness is considered to be that since the film thickness at a concave portion becomes thick as shown by (a) and the film thickness becomes thin at a convex portion as shown by (b), drying speed becomes uneven, and a crack is formed in the graphite by the effect of internal strain formed by shrinkage at the time of drying. Exfoliated graphite max clog into the shadow mask to cause deterioration of image quality.

To cope with this problem, usually in a process of producing a cathode ray tube, a step of removing foreign matter such as the above exfoliated graphite or glass fractions, is usually provided. The method for this step is that after the glass panel and the glass funnel are sealed together, the cathode ray tube is placed so that the neck portion points downwardly, and is vibrated or hit to discharge foreign matter from the neck portion which is opening. Since a glass funnel usually has a simple funnel shape, foreign matter slides down along the body portion of the glass funnel to the yoke portion and the neck portion to be discharged to the outside. However, when a step or a protrusion is provided as described above, these step or protrusion may prevent the discharge of foreign matter and the discharge may become insufficient.

This problem occurs also in a glass funnel in which a recess 19 is provided in the body portion disclosed in Japanese Patent No. 3383087. Namely, in a glass funnel provided with a recess 19 as shown in FIG. 7, a recess 20 is formed in the internal face, and the recess 20 captures foreign matter 8 and the foreign matter 8 can not be completely discharged. Since the direction of a cathode ray tube is changed to various directions before it is assembled into a TV set, if foreign matter remains thus in the recess 20, the foreign matter may come out into the tube to cause clogging of shadow mask and deteriorate image quality. Further, a glass funnel having a body portion provided with a recess 19 as shown in FIG. 7, is effective for avoiding concentration of vacuum stress, but it is difficult to achieve light-weight.

Also in a case of reducing the depth, since a cathode ray tube has a rear portion attached with a deflection device and accommodating an electron gun, such a cathode ray tube has a depth of at least several times as large as the depth of other type of display devices. Therefore, in order to design a TV set so that at least its peripheral portion looks flat, a glass funnel is desired to have such a shape that the depth of the opening end side of the body portion has as small depth as possible and is compact. If the shape shown in FIG. 7 is employed, the depth of entire body increases, which is not preferred in terms of design.

### PROBLEMS TO BE SOLVED BY THE INVENTION

The present invention has made under the above problems of prior art, and it is an object of the present invention to provide a glass bulb for cathode ray tube, comprising a glass funnel having a reduced depth, which can avoid stress concentration to a yoke portion, and in which foreign matter present in the inside can be easily discharged at a time of producing the cathode ray tube.

### MEANS FOR SOLVING THE PROBLEMS

To achieve the above object, the present invention provides a glass bulb for a cathode ray tube, comprising a glass panel and a glass funnel, the glass panel having an inner face forming a substantially rectangular phosphor screen, the glass funnel comprising a neck portion accommodating an electron gun, a yoke portion from a neck seal position to a yoke end, and a body portion from the yoke end to the seal edge portion; characterized in that D and H satisfy a relation 3.2≦D/H≦4.8 provided that the length of a diagonal line of the phosphor screen is D and the distance from the end of the diagonal line to the reference line of the glass funnel in the direction in parallel with bulb axis is H; the external shape of the yoke portion in cross section perpendicular to the bulb axis, at the portion of the reference line, is in a substantially rectangular shape; in a region where a height h of the body portion from the yoke end in the direction of bulb axis, satisfies 0.1H_{b}<h<0.3H_{b} provided that the height of the body portion in the direction of bulb axis is H_{b}, the external shape of the body portion in cross section perpendicular to the bulb axis is in a substantially rhombic shape and the direction of maximum diameter in the substantially rhombic shape is the same as the long axis direction of the funnel; and the minimum value of the differential value of h=f(s) is at least 0 provided that the distance from the yoke end in the direction perpendicular to the bulb axis is s.

In the above glass bulb for cathode ray tube, it is preferred that in a region where the height h satisfies 0.1H_{b}<h<0.3H_{b}, the external shape of the body portion in cross section perpendicular to the bulb axis, has a substantially rhombic shape, a coordinate (x, y) of an optional point on the profile line of the cross sectional shape, is present in a region constituted by curves represented by a formula (2×/Da)ⁿ+(2y/Di)ⁿ=1 where 1.4≦n<2.0 and provided that the diameter of the external shape in the long axis is Da and the diameter in the short axis is Di.

Further, the present invention provides a glass bulb for a cathode ray tube, comprising a glass panel and a glass funnel, the glass panel having an inner face forming a substantially rectangular phosphor screen, the glass funnel comprising a neck portion accommodating an electron gun, a yoke portion from a neck seal position to a yoke end, and a body portion from the yoke end to a seal edge portion; characterized in that D and H satisfy a relation 3.2≦D/H≦4.8 provided that the length of a diagonal line of the phosphor screen is D and the distance from the end of diagonal line to the reference line of the glass funnel in the direction in parallel with the bulb axis is H; the external shape of the yoke portion in cross section perpendicular to the bulb axis, is in a substantially rectangular shape, and in the external shape of the body portion in cross section perpendicular to the bulb axis in the region where a height h from the yoke end of the body portion in the direction of bulb axis satisfies 0.1H_{b}<h<0.3H_{b} provided that the height of the body portion in the direction of bulb axis is H_{b}, the maximum diameter portions of the external shape are present between the long axis and the respective diagonal axes, and an inwardly recessed intermediate portion between two maximum diameter portions in each short side is inwardly recessed; and the minimum value of the differential value of h=f(s) is at least 0 provided that the distance from the yoke end in the direction perpendicular to the bulb axis in the external shape is s.

In the above glass bulb for cathode ray tube, it is preferred that there is a relation d′≧d/2 provided that the distance between a point where a line connecting the two maximum diameter portions on the long axis side crosses the long axis of the glass funnel, and the bulb axis, is d, and the distance between a point where the outline of the inwardly recessed portion between the two maximum diameter portions located in each short side, crosses the long axis of the glass funnel, and the bulb axis, is d′.

In each of the above glass bulb for cathode ray tube, it is preferred that the differential value is at least 0.09.

Further, the present invention provides a cathode ray tube employing any one of the above glass bulb for a cathode ray tube.

According to the present invention, in a flat cathode ray tube whose depth is reduced, by making a portion of a body portion of a glass funnel close to a yoke end, to have the above shape, vacuum stress formed in the glass funnel can be evenly distributed. By such a construction, it is possible to suppress the increase of weight even if the cathode ray tube becomes flat and large sized, and to avoid stress concentration in the yoke portion and suppress the stress in the yoke portion to maintain high reliability. Further, since there is no step, protrusion or recess in the body portion, it is possible to coat the inner face of the body portion with graphite with uniform film thickness, and to easily remove foreign matter present inside of the glass bulb. Further, since there is no significant recess and protrusion in the body portion, such a construction has an effect of making external appearance of a television set more flat.

### BRIEF DESCRIPTION OF THE DRAWINGS

FIG. 1 is a cross-sectional view along a diagonal line of a glass bulb according to an embodiment of the present invention.

FIG. 2 is a bottom view of the glass bulb of FIG. 1 observed from the side of glass funnel.

FIG. 3(A) is a graph showing the external shape of a cross section of a glass funnel according to an embodiment of the present invention, and FIG. 3(B) is a graph showing a derived function of the external shape of the cross section of FIG. 3(A).

FIG. 4 is a cross-sectional view showing cross sections in various directions of the glass funnel of FIG. 2.

FIG. 5 is a bottom view of a glass bulb according to another embodiment of the present invention, corresponding to FIG. 2.

FIG. 6 is a cross-sectional view showing the structure of a conventional cathode ray tube.

FIG. 7 is a cross-sectional view of a conventional glass bulb (Japanese Patent No. 3383087).

FIG. 8 is a partial cross-sectional view of a conventional glass funnel (WO03/34461).

FIG. 9 is a partial cross-sectional view of a conventional glass funnel (JP-A-2001-332190).

### EXPLANATION OF NUMERALS

1: Glass panel
2: Glass funnel
3: Body portion
4: Yoke portion
5: Neck portion
6: Electron gun
7: Deflection coil
8: Foreign matter
9: Internally coated graphite
10: Seal portion
11: Electron beam
12: Phosphor film
13: Aluminum film
14: Shadow mask
15: Stud pin
16: Reinforcement band
17: Anode button
18: Step portion
19: Recess
20: Concave portion
A: Bulb axis
B: Reference line
C: Diagonal axis
D: Long axis
E: Short axis
F: Seal edge portion (opening end)
G: Neck end
T: Yoke end

### DETAILED DESCRIPTION OF THE PREFERRED EMBODIMENTS

In the present invention, a vacuum envelope of cathode ray tube is constituted by a glass bulb for cathode ray tube, comprising a glass panel (hereinafter, referred also to as panel) having a substantially rectangular shape and a glass funnel. The present invention is to make the shape of a body portion of the glass funnel around a yoke portion, to be a predetermined shape, to suppress a stress in the yoke portion due to deformation of the body portion.

In a common cathode ray tube, the neck portion is positioned more backwardly, and the yoke portion is positioned in front of the neck portion, and a body portion is provided so that it bridges the yoke portion and a glass panel. Further, in order to reduce the depth of the cathode ray tube, the depth of glass funnel is made small as compared with the width of the glass funnel. Specifically, provided that a diagonal length of a phosphor screen formed on a panel and having a substantially rectangular shape, is D, and the distance from the end of the diagonal line to the reference line of the glass funnel in a direction in parallel with the tube axis, is H, D and H satisfy 3.2≦D/H. Since D is determined as the size of the image plane of the cathode ray tube, it is necessary to make H at most 1/3.2 based on D to reduce the depth. In the above, the reference line of glass funnel is defined by a standard ED-2134B of Japan Electronics and Information Technology Industries Association (JEITA), which corresponds to a position specified as a reference in designing a cathode ray tube, and is obtainable as a line passing through the deflection center set in the yoke portion and perpendicular to the tube axis.

Meanwhile, since the body portion of glass funnel has such a flat shape, the body portion of glass funnel receives a strong deformation since it is pushed inwardly towards the panel when the inside of the glass funnel is evacuated. Since the yoke portion is connected with the body portion so that the yoke portion protrudes from the center of the body portion as described above, the deformation of the body portion is finally concentrated in the yoke portion, which deteriorates the strength of the cathode ray tube.

Further, in the body portion, different deformations by the effect of vacuum stress, occur in short side portions, long side portions and diagonal portions since the glass funnel has a funnel shape having a substantially rectangular seal edge portion (opening) and the rigidities of the above portions are different. Specifically, the short side portions are the most significantly deformed so as to cave inwardly, the long side portions are the second significantly deformed, and the diagonal portions are the least significantly deformed. Therefore, when the inside of a cathode ray tube is evacuated (depressed), the diagonal portions of the yoke portion are complexly deformed as influenced by the deformations of long-side portions and short-side portions, and further deformed so as to entirely shift towards short sides. As a result, a high tensile stress is formed at diagonal portions or the short side portions of the yoke portion.

In order to suppress such stresses in the yoke portion, it is effective to adjust the deformation of the body portion before it propagates to the yoke portion. As described above, in prior art, protrusions or steps having high rigidity are provided in a region of body portion near the yoke portion, namely, in the peripheral region of yoke portion, to adjust the deformation or reduce the deformation itself. However, these protrusions or steps have been causing deterioration of productivity in the process of producing a cathode ray tube. Therefore, it is necessary to make an inner face of the body portion of a funnel glass to have a smooth shape having a monotone slope towards the yoke portion, namely, a smooth shape having no steps, protrusions or recesses. Under these circumstances, the present invention employs a smooth shape for the body portion around the yoke portion to propagate the deformation in the short side portions to the long side portions. By such a construction, deformation propagated to the yoke portion is averaged, and the deformation of yoke portion is averaged, whereby it is possible to reduce the stress formed in the yoke portion. Further, such a shape of the body portion does not deteriorate the productivity of cathode ray tube, and since the body portion has no extra shape such as protrusion or step, it is possible to achieve such a construction without increasing weight, and achieve a slim appearance in terms of design.

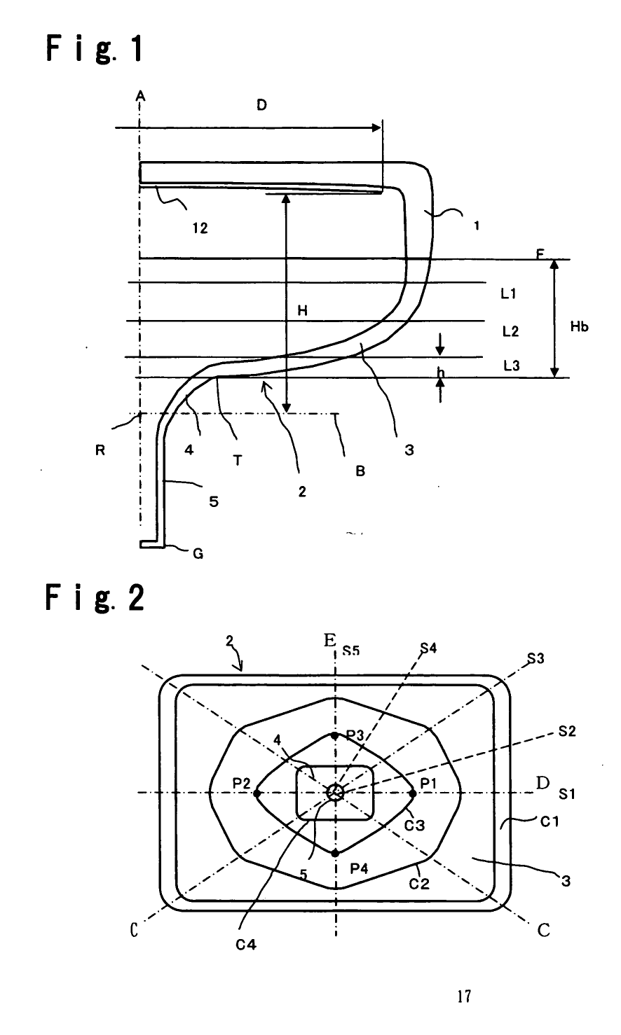

Then, the present invention will be described with reference to drawings. These drawings show preferred embodiments of the present invention, but the present invention is not limited to these embodiments. FIG. 1 is a schematic view of a cross section along a diagonal line of a glass bulb for a cathode ray tube, and FIG. 2 is a plan view showing the glass bulb observed from the side of funnel glass. Here, constituents common with those with FIG. 6 are designated by the same reference numerals, and explanations of these constituents are omitted.

In FIG. 1, A is a tube axis of the cathode ray tube, R is a deflection center, B is a reference line, T is a yoke end, F is a seal edge portion (opening end) of a body portion 3, and G is an end of a neck portion 5. The reference line B is, as described above, a line passing through the deflection center R and perpendicular to the tube axis A, and the reference line B can be set in the design of cathode ray tube. The yoke end T is an interface between the upper end of the yoke portion 4 and the lower end of the body portion 3. The yoke portion 4 and the body portion 3 can be partitioned by the yoke end T. Practically, they can be distinguished by the appearance that the surface of the yoke portion 4 to which a deflection coil is attached, is generally finner than that of body portion 3, and that they have different curvatures. Further, the upper end F of body portion 3 is a seal edge portion (opening end) having a substantially rectangular shape to be sealed with a glass panel 1.

In the glass funnel 2 of the present invention, the yoke portion 4 is a portion generally called as a rectangular yoke portion, which has a cross section perpendicular to the bulb axis A, having a substantially rectangular shape as shown by C4 in FIG. 2, at the position of reference line B. In this case, since the yoke portion 4 spreads like a trumpet shape towards the yoke end T, the external shape of a cross section of the yoke portion 4 perpendicular to the bulb axis A, is not uniform but has the shape or the size continuously changing along the direction of bulb axis A. Namely, the lower end of the yoke portion 4 has a shape being the same or similar to the shape of neck portion 5 so as to be sealed with the neck portion 5 but the cross-sectional shape gradually expands and becomes more rectangular towards the yoke end, becomes a substantially rectangular shape as shown by C4 in the vicinity of the reference line B, and finally, becomes a shape close to the shape of the lower end of the body portion 3 so as to smoothly continue to the body portion 3. The present invention defines such a rectangular yoke portion in terms of the external shape in a cross-section at the portion of reference line B and perpendicular to the bulb axis A.

Here, in the glass bulb according to the present invention, since the internal shape is the same or substantially the same as the external shape, e.g. the internal shape of a cross section of the yoke portion 4 perpendicular to the bulb axis, is similar to the external shape of the cross section. This relation is applicable to portions other than the yoke portion. The reason that the shapes of yoke portion and body portion of the glass funnel, are defined by the external shape of a cross section perpendicular to the bulb axis, namely, by external appearance, is because of the identity of the internal and external shapes and the fact that the strength of glass funnel is mainly dominated by a stress in the external surface.

Meanwhile, the glass panel 1 has an inner face on which a phosphor screen 12 having a substantially rectangular shape is formed as shown in FIG. 1. In FIG. 1, D shows the length of a diagonal line of the phosphor screen 12, H is the distance from the end of the length D of a diagonal line of the phosphor screen 12 to the reference line B in a direction in parallel with the tube axis A. Further, H_{b} is a height of the body portion 3 in the tube axis direction, which is the distance from the yoke end T to the seal edge portion F. h of FIG. 1 shows a height in the tube-axis direction from the yoke end T in the body portion 3.

Three profiles C3, C2 and C1 shown in FIG. 2 are outlines defined by crossing the external surface of the funnel glass and planes L3, L2 and L1 perpendicular to the bulb axis at positions where h in FIG. 1 is 0.18H_{b}, 0.6H_{b} and 0.8H_{b} respectively. In other words, they show external shapes of cross sections of the body portion 3 at L3, L2 and L1 respectively. This example is characterized in that, as a method for finally adjusting the deformation of body portion 3, the external shape of a cross section of the body portion 3 perpendicular to the bulb axis in a region where h is 0.1H_{b}<h<0.3H_{b}, is made to be a substantially rhombic shape having the largest diameter in the direction of long axis as shown by C3. Namely, C3 represents the external shape of the body portion in the region where h is 0.1H_{b}<h<0.3H_{b}, and P1 to P4 are apexes of the substantially rhombic shape. In this case, the substantially rhombic shape may be any shape so long as it is visually recognized as a rhombic shape by a rough observation, and its shape is not particularly limited. Further, the substantially rhombic shape is not necessarily constant in a region where h is 0.1H_{b}<h<0.3H_{b}, but the shape may be continuously changed depending on the position of the cross section in the body portion, namely depending on h to be described later.

In the above, the reason why h is made to be at least 0.1H_{b}, is because since the region of body portion 3 where h is at most 0.1H_{b} is a region adjacent to the yoke portion 4, and if the external shape of the region of the body portion is made to be a substantially rhombic shape, smooth continuity to the rectangular yoke portion might not be obtained. On the other hand, a region where h is at least 0.3H_{b} does not directly relate to the object of the present invention in terms of the structure since the region is far from the yoke portion and if the upper portion of the body portion 3 where h exceeds 0.3H_{b}, is made to have a substantially rhombic shape, continuity to the seal edge portion having a substantially rectangular shape, can not be obtained, which may cause a problem from the aspect of design.

When two opposing apexes of a substantially rhombic shape shown by C3 in FIG. 2, are pressed, the force is propagated along sides of the substantially rhombic shape, and the substantially rhombic shape is deformed so that other two apexes protrude outwardly. Since the short sides of the glass funnel 2 deform the most significantly, P1 and P2 are pushed inwardly from both sides. As a result, the profile of the rhombic shape propagates the force to P3 and P4 to balance with the deformation of long sides. In diagonal directions, since corners having high rigidity are not deformed, the rhombic shape is deformed so that diagonal portions follow the deformation of short sides and long sides. Therefore, by making the external shape of a cross section of the body portion 3 where 0.1H_{b}<h<0.3H_{b}, a substantially rhombic shape having the largest diameter in the direction of long axis of the body portion, the deformation of the body portion 3 is adjusted to balance before being propagated to the yoke portion 4, whereby it is possible to prevent concentration of deformation in the yoke portion 4. By this construction, stress formed in the yoke portion can be reduced. This effect is the most significant in the case of rhombic shape. However, a desired effect can be obtained even if the apexes of the rhombic shape are rounded to have a continuous surface to constitute the body portion by a smooth surface.

Further, in a case where the external shape of a cross section of the body portion 3 perpendicular to the tube axis in a region where h is 0.1H_{b}<h<0.3H_{b}, is a substantially rhombic shape, higher effect can be obtained by making the shape of the body portion 3 so that the coordinate (x, y) of an optional point on the outline of the external shape is present in a region constituted by curves represented by a formula (2×/Da) n+(2y/Di)ⁿ=1 where 1.4<n<2.0 provided that the diameter in the long axis of the substantially rhombic shape is Da and the diameter in the short axis is Di. When n=2, the above formula represents a positive ellipse and the effect of rhombic shape can not be obtained.

When n is smaller than 2, the shape becomes a substantially rhombic shape and the desired effect can be obtained. Further, when n is smaller than 1.4, the effect of rhombic shape can be sufficiently obtained but a smooth curved surface can not be obtained since the radius of apexes is too small, which may cause a problem such as exfoliation of internally coated graphite. Here, C2 in FIG. 2 shows an outline of the portion smoothly connecting the above-mentioned substantially rhombic shape (C3) near the yoke portion and the substantially rectangular shape (C1) near the seal edge portion. C2 has a substantially octagonal shape in the Figure. However, the shape is not limited to this shape so long as it can smoothly connect the above shapes.

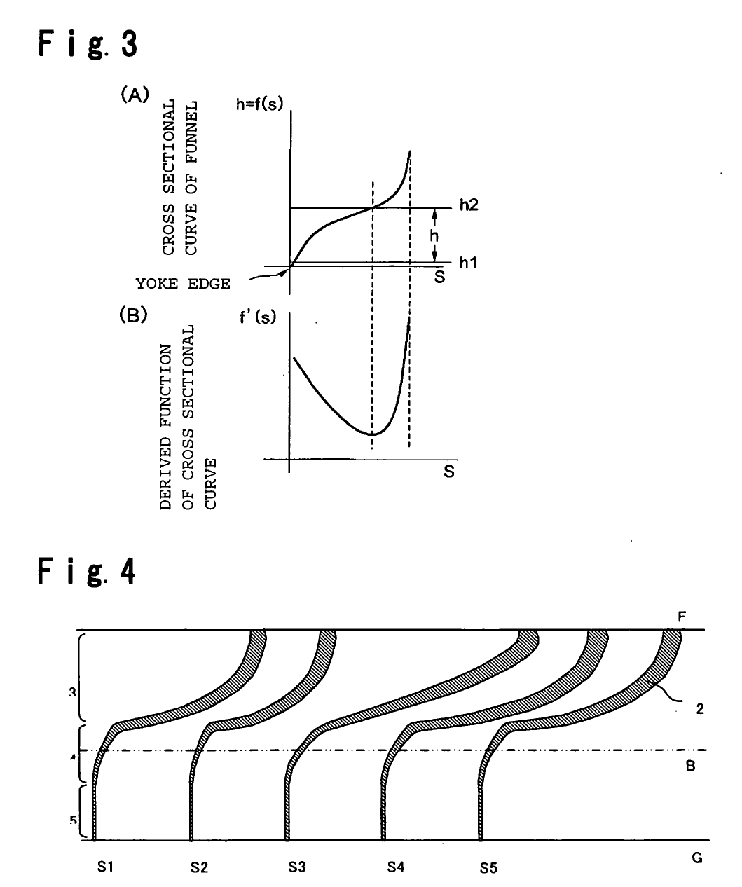

The present invention is characterized in that the external shape of a cross section of the body portion 3 perpendicular to the tube axis in the region where h satisfies 0.1H_{b}<h<0.3H_{b}, is made to be a substantially rhombic shape, and the minimum value of the differential Δh/Δs of h=f(s) is made to be at least 0 provided that the distance from the yoke end, accurately from the yoke end in the outline of the cross section, in a direction perpendicular to the tube axis A is designated as s. From now, this characteristic will be described with reference to FIG. 3.

FIG. 3(A) shows the external shape of a cross section of the glass funnel wherein s is the distance from the yoke end. In the Figure, h₁ shows the position where h=0.1H_{b}, h₂ shows the position where h=0.3H_{b}, and h is within the range of 0.1H_{b}<h<0.3H_{b}. Therefore, in the present invention, the minimum value of the differential value Δh/Δs of the external shape of the body portion where h is in the above range, is made to be at least 0. FIG. 3(B) shows a derived function which provides differential value (f′(s)) of the external shape in a region of h, and the derived function becomes a parabolic shape as shown in the figure in the case where the external shape is a curve of FIG. 3(A). By looking at the differential value (derived function), the nature of the external shape of the region can be assumed. Namely, if the external shape is such that h increases as s increases, the value of derived function becomes positive. However, in such a case where a recess is formed in the body portion, the value of derived function becomes negative in the inflection region of the recess since h decreases as s increases in such a region. Further, since the differential value decreases as the increase rate of h to s decreases, a derived function having generally small value in a predetermined range of s, indicates an external shape significantly changing in the direction perpendicular to the tube axis in the range. Namely, the derived function indicates a gently sloped surface.

According to the present invention, by making the external shape of the body portion in the region where h satisfies 0.1H_{b}<h<0.3H_{b}, to be the above shape (substantially rhombic shape) which further satisfies that the minimum value of the differential value is at least 0, it is possible to form a body portion having no recess in the above region so that there is no problem in discharging foreign matter. Further, by making the above differential value preferably at least 0.09, it is possible to constitute the region closely around the yoke portion by a gently sloped surface which smoothly continues without having a steep change such as a bend or a step. By such a construction, it becomes possible to reduce the height of the body portion in the direction of the tube axis, which facilitates to obtain a flat glass funnel having high reliability and a suppressed weight.

FIG. 4 is a view showing vertical cross sections of a glass funnel along the lines S1 to S5 of FIG. 2. As evident from FIG. 4, there is no bend in any direction in the body portion of the glass funnel of the present invention, and the body portion has a monotone slope towards the yoke portion, which makes discharge of foreign matter easy. Further since there is no step or irregularity, the depth of the body portion is not increased and a compact shape is formed. Such a compact shape having no step or irregularity, is excellent also in terms of design. Here, the above effects of this example is applicable completely in the same manner to glass funnels of other embodiments to be described later.

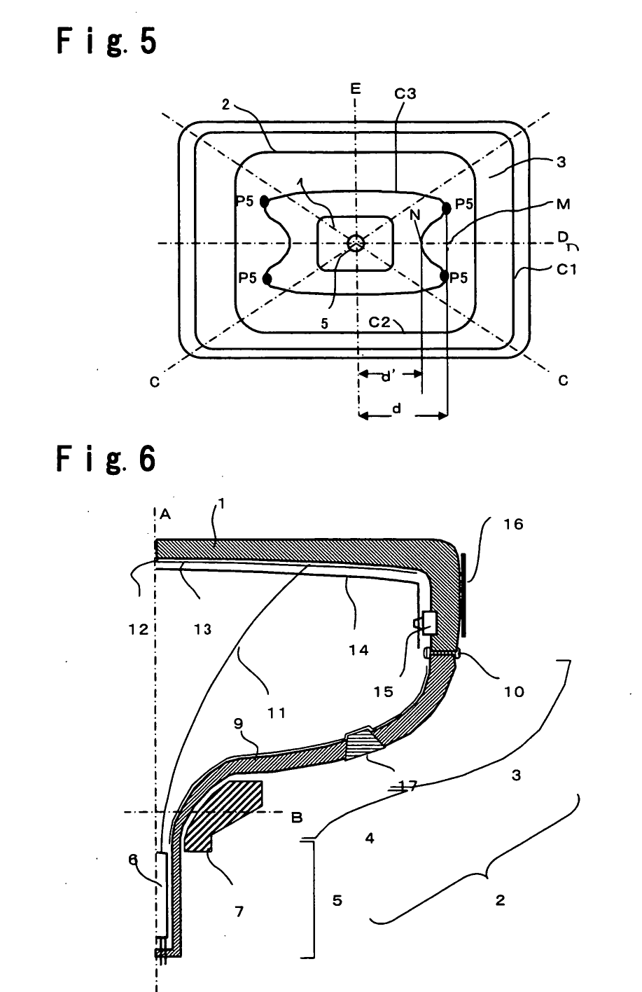

FIG. 5 is a plan view of a cathode ray tube according to another embodiment of the present invention observed from the side of glass funnel. C3, C2 and C1 of FIG. 5 correspond to C3, C2 and C1 of the above FIG. 2, respectively, and in the same manner as in FIG. 2, they are external shapes of cross sections perpendicular to the tube axis of the body portion at positions where h is 0.18H_{b}, 0.6H_{b} and 0.8H_{b} respectively (refer to FIG. 1). The glass funnel of this example is the same as the glass funnel of FIG. 2 except in the external shapes of C3 and C2. Among C3 and C2, particularly the difference in C3 is significant. From now, the glass funnel of this example will be described with reference to FIG. 5. Here, description of the portions common with FIG. 2 are omitted.

In the glass funnel of this example, each of C3 and C2 has a substantially rectangular shape as shown in FIG. 5, and its long axis and short axis substantially correspond to the long axis D and the short axis E of the glass funnel 2 respectively. In C3 which shows the external shape of a cross section of the body portion in the region where h satisfies 0.1H_{b}<h<0.3H_{b}, maximum-diameter-portions P5 of the external shape are provided between the long axis D and diagonal axes C. Each of the maximum-diameter-portion P5 may be located any location so long as it is between the long axis D and a diagonal axis C. Further, since the maximum diameter of C3 is provided along a line connecting maximum-diameter-portions P5 in a diagonal direction across the tube axis, the maximum diameter is also provided between the long axis D and the diagonal axis C in the same manner.

Therefore, the glass funnel of this example is different from the glass funnel of FIG. 2 in which the shape of C3 is a substantially rhombic shape and the direction providing the maximum diameter is the same as the long axis direction of the glass funnel. However, they are common in that the shape of body portion in the vicinity of yoke portion is improved to reduce the stress formed in the rectangular yoke portion of a flat glass funnel. Namely, by thus providing the maximum-diameter-portions P5 between the long axis D and the diagonal axes C, a gentle curve is formed on each of the long side of body portion near the yoke portion, and by the effect of the bulges, deformation propagating from the body portion to the yoke portion can be averaged, whereby the stress formed in the yoke portion can be reduced.

Further, in the glass funnel in which the maximum-diameter-portions P5 are provided between the long axis and the diagonal axes, the external shape of the cross section of the body portion in a region where h satisfies 0.1H_{b}<h<0.3H_{b}, has a shape in which the portion between the two maximum-diameter-portions in each short side is inwardly recessed as shown by C3 of FIG. 5, namely, the portion has so-called substantially bobbin shape. The degree of recess in the substantially bobbin shape may change depending on the position of cross section in the region where h satisfies 0.1H_{b}<h<0.3H_{b}. Typically, the degree of recess is small where h is close to 0.1H_{b}, gradually increases as h increases, and becomes small again as h becomes close to 0.3H_{b}. Therefore, in the portions where h is close to 0.1H_{b} or 0.3H_{b}, the cross section has a shape infinitely close to a substantially rectangular shape, and it becomes a prominent bobbin shape in approximately the middle of these portions.

In such a substantially bobbin-shaped cross section, if the shape between two maximum-diameter-portions in each short side recesses too deeply, a large bulges are formed on both sides of the recess and the shape of the portion of the body portion steeply changes, whereby it becomes difficult to obtain a body portion smoothly continuing. In the present invention, a preferred range of this recess can be specified by the following method. Namely, as shown in FIG. 5, it is preferred to satisfy d′≦d/2 provided that the distance between a point M where a line connecting two maxim-diameter portions P5 in each short side crosses the long axis D of the glass funnel 2, is designated as d, the distance between the point N (which corresponds to the bottom of the recess between maximum-diameter portions P5) where the external shape recessed inwardly between two maxim-diameter-portions P5 in each short side crosses the long axis D of the glass funnel 2, and the glass axis is designated as d′. If d′≦d/2, since considerably deep grooves or recesses are formed in the short side portions of the body portion as described above, not only stress concentration is formed or a cooling problem is occurred at a time of producing a glass funnel, but also it becomes difficult to form a body portion smoothly continuing, such being not preferred.

On the other hand, the external shape of the body portion in a region where h≧0.3H_{b}, is a substantially rectangular shape represented by C2 of FIG. 5, which smoothly continues to the seal edge portion having a rectangular shape. As a result, the glass funnel of this example has a body portion having a rectangular shape in all region from the yoke portion to the seal edge portion.

Thus, by making the external shape of the body portion in the region where h satisfies 0.1H_{b}<h<0.3H_{b} to be a shape in which maximum-diameter-portions P5 are provided between the long axis and diagonal axes, and making the shape a substantially bobbin shape at the same time, a gentle curve is formed from a short side portion towards a long side portion in the above region of body portion. Such a bobbin-shaped external shape has a function of propagating deformation in the short side portion to the long side portion and reducing the rigidity of diagonal portions to adjust deformation.

Further, by making the external shape of the portion of the body portion close to the yoke portion a bobbin shape, anisotropy of rigidity around the yoke portion is increased. Namely, the rigidity is relatively increased in the short side portion, namely, in the direction along long axis, and the rigidity relatively decreases in the long side portion, namely, in the direction of short axis. Thus, a structure which is hardly bent in the long axis direction but easily bent in the short axis direction, is formed. As a result, deformation in the short side portion (long axis direction) is suppressed, and the long side portion (short axis direction) is increased since the long side portion is supported by the short side portion via the yoke portion, whereby deformations of both of these long and short side portions are balanced as the deformation of the long sides are increased.

In the present invention, by improving the shape of body portion, balance of rigidity in the body portion is skillfully adjusted. However, in such a glass bulb having high flatness of D/H<4.8, since entire structure becomes too flat and the body portion itself becomes a flat shape close to a plane, it is not possible to make the rigidity of portions of the body portion differently and the present invention is not applicable to such a structure.

### EXAMPLES

From now, Examples of the present invention and Comparative Examples are described. Glasses in these Examples and Comparative Examples are ones as shown in Table 4, which are usually used for cathode ray tubes. Glass funnels of these Examples and Comparative Examples are designed by forming their shapes in a three-dimensional CAD and calculating stress in these glasses by using a definite element method. The design was made under the conditions that the upper limit of stress σ_{y} of yoke portion and stress σ_{b} of body portion were set to be 9 MPa from the viewpoint of preventing delayed fracture, and the upper limit of the stress σₛ of seal portion was set to be 8 MPa. Table 1 shows examples where the maximum diameter of effective screen is 676 mm and the vertical-horizontal ratio is 4:3. Table 2 shows examples where the maximum diameter of effective screen is 760 mm and the vertical-horizontal ratio is 16:9. FIG. 3 shows as a case where the external shape is a substantially bobbin shape (refer to FIG. 5), examples where maximum diameters of elective screen are 760 mm and 860 mm and the vertical-horizontal ratio is 16:9.

### Example 1

An example where the maximum diameter of effective screen is 676 mm and the cross-sectional shape of the body portion in the region where 0.1H_{b}<h<0.3H_{b} (hereinafter referred to as portion of the present invention) is the substantially rhombic shape shown in FIG. 2. In this example, stress in each portion was within the criteria and the weight could be the lightest in design.

### Example 2

An example in which the cross-sectional shape of Example 1 having a substantially rhombic shape, is changed, in which the stress in the yoke portion is designed to be further reduced.

### Example 3

An example in a case where the maximum diameter of effective screen is 760 mm and the cross-sectional shape of the portion of the present invention is the substantially rhombic shape shown in FIG. 2. In this example, the stress in the yoke portion could be lower by 1.4 MPa as compared with that of Comparative Example 4 without having the structure of the present invention, and the stress satisfies the criteria. The weight could be approximately same as that of Comparative Example 4 in design.

### Example 4

An example where the cross-sectional shape of substantially rhombic shape of Example 2 is changed. In this example, a design providing the same effect as Example 2 was achieved.

### Example 5

An example where the maximum diameter of effective screen is 760 mm and the cross-sectional shape of the portion of the present invention is the substantially bobbin shape shown in FIG. 5. In this example, the stress in the yoke portion could be reduced by 2.2 MPa in design as compared with that of Comparative Example 5 which does not have the structure of the present invention in the portion of the present invention, and the stress satisfies the criteria. The weight could also be lighter than that of Comparative Example 5 in design.

### Example 6

An example where the maximum diameter of effective screen is 860 mm and the cross-sectional shape of the portion of the present invention is the substantially bobbin shape shown in FIG. 5. In this example, the stress in the yoke portion became lower by 1.4 MPa than the stress of yoke portion of Comparative Example 6 which does not have the structure of the present invention, and the stress satisfies the criteria.

### Comparative Example 1

A Comparative Example where the design was made under the same design conditions as Example 1 except that the cross-sectional shape of the portion of the present invention of the body portion was a substantially rectangular shape. Since the stress in the yoke portion is higher than the criteria, reliability becomes low and it can not be used.

### Comparative Example 2

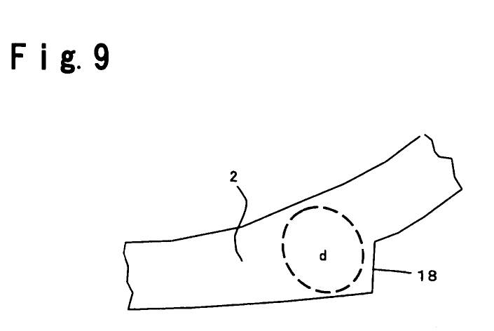

An example shown in FIG. 9 which was designed under the same design conditions as in Example 1. The stress in the yoke portion is within the criteria, but, as understandable by comparing T1 and T2, there is a portion where the thickness drastically changes within a length of 20 mm. For this reason, this design is not suitable for production of glass funnel.

### Comparative Example 3

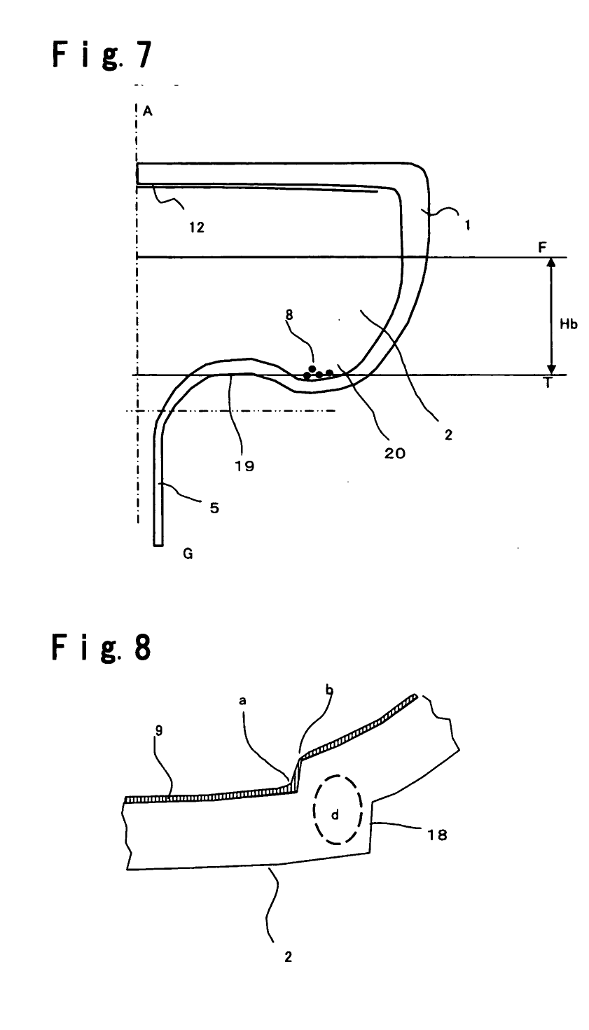

An example shown in FIG. 7 which was designed under the same design conditions as in Example 1. The stress in the yoke portion is within the criteria, but the lowest point H_{L} is located below the lower end (which corresponds to yoke end T) of the body portion as shown in FIG. 7, which makes discharge of foreign matter difficult. For this reason, this design is not suitable for producing a cathode ray tube. Besides this problem, when the diameters in various axis directions are compared, they are different by more than 100 mm and such a design is not advantageous in terms of design of appearance.

### Comparative Example 4

An example where the design was made under the same design conditions as in Example 4 except that the cross-sectional shape of the portion of the present invention in the body portion is a substantially rectangular shape. Since the stress in the yoke portion is higher than the criteria, the reliability is low and this design is not usable.

### Comparative Example 5

An example where the design was made under the same design conditions as in Example 5 except that the cross-sectional shape of the portion of the present invention in the body portion is a substantially rectangular shape. Since the stress in the yoke portion is higher than the criteria, the reliability is low and this design is not usable.

### Comparative Example 6

An example where the design was made under the same design conditions as in Example 6 except that the cross-sectional shape of the portion of the present invention in the body portion is a substantially rectangular shape. Since the stress in the yoke portion is higher than the criteria, the reliability is low and this design is not usable.

TABLE 1

| | | | | Comp. | Comp. | Comp. |
|---|---|---|---|---|---|---|
| | | Ex. 1 | Ex. 2 | Ex. 1 | Ex. 2 | Ex. 3 |
| Maximum diameter of effective | D mm | 676.0 | 676.0 | 676.0 | 676.0 | 676.0 |
| screen | | | | | | |
| Distance from reference line to the | H mm | 196.3 | 196.3 | 196.3 | 196.3 | 196.3 |
| end of elective screen | | | | | | |
| D/H | | 3.4 | 3.4 | 3.4 | 3.4 | 3.4 |
| Maximum diameter of panel | mm | 724.8 | 724.8 | 724.8 | 724.8 | 724.8 |
| Wall thickness of central portion | mm | 13.0 | 13.0 | 13.0 | 13.0 | 12.5 |
| of face | | | | | | |
| Total height of panel | mm | 85.5 | 85.5 | 85.5 | 85.5 | 85.5 |
| Wall thickness of seal edge portion | Ts mm | 13.5 | 13.5 | 13.5 | 13.5 | 13.5 |
| (short axis) | | | | | | |
| Height of body portion | H_{b} mm | 100.0 | 100.0 | 100.0 | 100.0 | 100.0 |
| Diameter in short axis direction at | Dᵢ mm | 310.4 | 310.4 | 303.1 | 303.1 | 417.5 |
| a height of 0.18 H_{b} | | | | | | |
| Diameter in long axis direction at | Dₐ mm | 341.7 | 341.7 | 325.0 | 325.0 | 455.4 |
| a height of 0.18 H_{b} | | | | | | |
| Diameter in diagonal axis direction | D_{d} mm | 315.5 | 295.0 | 341.3 | 341.3 | 512.2 |
| at a height of 0.18 H_{b} | | | | | | |
| Diameter of ellipse (positive | Dₒ mm | 329.4 | 329.4 | 316.6 | 316.6 | 440.6 |
| ellipse) of n = 2 in diagonal axis | | | | | | |
| direction | | | | | | |
| Diameter of ellipse of n = 1.4 in | Dₗ mm | 284.7 | 284.7 | 273.8 | 273.8 | 380.9 |
| diagonal axis direction | | | | | | |
| Wall thickness at a point 125 mm | T1 mm | 9.6 | 9.6 | 9.1 | 17.7 | 11.8 |
| from the center on long axis | | | | | | |
| Wall thickness at a point 145 mm | T2 mm | 9.4 | 9.4 | 9.2 | 9.2 | 12.2 |
| from the center on long axis | | | | | | |
| Lowest point of body portion | H_{L} mm | 0.0 | 0.0 | 0.0 | 0.0 | −30.0 |
| Maximum stress in yoke portion | σ_{y} MPa | 9.0 | 8.6 | 10.5 | 8.2 | 7.2 |
| Maximum stress in body portion | σ_{b} MPa | 7.0 | 7.2 | 6.6 | 7.6 | 6.4 |
| Maximum stress in seal edge portion | σₛ MPa | 7.4 | 7.3 | 7.1 | 7.6 | 7.8 |
| Weight of funnel glass | kg | 10.0 | 10.0 | 10.1 | 10.5 | 11.2 |
| Weight of panel | kg | 20.6 | 20.6 | 20.6 | 20.8 | 20.3 |
| Total weight of glass bulb | kg | 30.6 | 30.6 | 30.7 | 31.3 | 31.5 |

TABLE 2

| | | | | Comp. |
|---|---|---|---|---|
| | | Ex. 1 | Ex. 2 | Ex. 1 |
| Maximum diameter of effective screen | D mm | 760.0 | 760.0 | 760.0 |
| Distance from reference line to the | H mm | 195.3 | 195.3 | 195.3 |
| end of elective screen | | | | |
| D/H | | 3.9 | 3.9 | 3.9 |
| Maximum diameter of panel | mm | 814.8 | 814.8 | 814.8 |
| Wall thickness of central portion of face | mm | 12.0 | 12.0 | 12.0 |
| Total height of panel | mm | 100.0 | 100.0 | 100.0 |
| Wall thickness of seal edge portion | Ts mm | 16.0 | 16.0 | 16.0 |
| (short axis) | | | | |
| Height of body portion | H_{b} mm | 90.0 | 90.0 | 90.0 |
| Diameter in short axis direction at a | Dᵢ mm | 253.6 | 253.6 | 253.6 |
| height of 0.13 H_{b} | | | | |
| Diameter in long axis direction at a | Dₐ mm | 358.2 | 358.2 | 358.2 |
| height of 0.13 H_{b} | | | | |
| Diameter in diagonal axis direction at a | D_{d} mm | 301.5 | 310.0 | 337.6 |
| height of 0.3 H_{b} | | | | |
| Diameter of ellipse (positive ellipse) of | Dₒ mm | 321.8 | 321.8 | 321.8 |
| n = 2 in diagonal axis direction | | | | |
| Diameter of ellipse of n = 1.4 in | Dₗ mm | 278.4 | 278.4 | 278.4 |
| diagonal axis direction | | | | |
| Maximum stress in yoke portion | σ_{y} MPa | 8.7 | 9.0 | 10.1 |
| Maximum stress of body portion | σ_{b} MPa | 7.2 | 7.2 | 6.7 |
| Maximum stress in seal edge portion | σₛ MPa | 7.5 | 7.5 | 6.0 |
| Weight of funnel glass | kg | 11.0 | 11.0 | 10.9 |
| Weight of panel | kg | 26.9 | 26.9 | 26.9 |
| Total weight of glass bulb | kg | 37.9 | 37.9 | 37.8 |

TABLE 3

| | | Ex. 5 | Comp. Ex. 5 | Ex. 6 | Comp. Ex. 6 |
|---|---|---|---|---|---|
| Maximum diameter of effective | D mm | 760.0 | 760.0 | 860.0 | 860.0 |
| screen | | | | | |
| Distance from reference line to the | H mm | 198.9 | 198.9 | 200.5 | 200.5 |
| end of elective screen | | | | | |
| D/H | | 3.8 | 3.8 | 3.5 | 3.5 |
| Vertical-horizontal ratio of | | 16:9 | 16:9 | 16:9 | 16:9 |
| effective screen | | | | | |
| Maximum diameter of glass | mm | 812.8 | 812.8 | 920.0 | 920.0 |
| Wall thickness of central portion | mm | 12.0 | 12.0 | 17.0 | 17.0 |
| of face | | | | | |
| Total height of panel | mm | 93.0 | 93.0 | 110.0 | 110.0 |
| Wall thickness of seal portion | Ts mm | 17.5 | 17.5 | 14.0 | 14.0 |
| (short axis) | | | | | |
| Height of body portion | H_{b} mm | 98.0 | 98.0 | 135.0 | 135.0 |
| x coordinate of a point on long | Xd mm | 198.5 | 198.5 | 273.4 | 273.4 |
| axis at a height of 0.18 H_{b} | | | | | |
| y coordinate of a point on short | Yd mm | 142.1 | 142.1 | 176.2 | 176.2 |
| axis at a height of 0.18 H_{b} | | | | | |
| x coordinate of a point on diagonal | Xd mm | 180.4 | 180.4 | 212.5 | 212.5 |
| axis at a height of 0.18 H_{b} | | | | | |
| y coordinate of a point on diagonal | Yd mm | 101.5 | 101.5 | 119.6 | 119.6 |
| axis at a height of 0.18 H_{b} | | | | | |
| x coordinate of maximum-diameter- | Xp mm | 219.0 | 180.4 | 290.3 | 212.5 |
| portion at a height of 0.18 H_{b} | | | | | |
| y coordinate of maximum-diameter- | Yp mm | 50.4 | 101.5 | 54.6 | 119.6 |
| portion at a height of 0.18 H_{b} | | | | | |
| Maximum stress in yoke portion | σ_{y} MPa | 7.8 | 10.0 | 9.0 | 10.4 |
| Maximum stress in body portion | σ_{b} MPa | 7.8 | 7.5 | 9.9 | 9.9 |
| Maximum stress in seal edge portion | σₛ MPa | 7.2 | 7.5 | 7.4 | 7.4 |
| Weight of funnel glass | kg | 25.1 | 25.1 | 16.4 | 16.4 |
| Weight of panel | kg | 12.2 | 12.4 | 36.3 | 36.3 |
| Total weight of glass bulb | kg | 37.3 | 37.5 | 52.7 | 52.7 |

TABLE 4

| | | Glass | | |
|---|---|---|---|---|
| | | Glass panel | Funnel glass | Neck glass |
| Young's modulus | (GPa) | 75 | 69 | 62 |
| Poission's ratio | | 0.21 | 0.21 | 0.23 |
| Density | g/cm³ | 2.78 | 3.06 | 3.29 |

### INDUSTRIAL APPLICABILITY

The present invention has an object to facilitate to reduce the depth of a cathode ray tube, and accordingly, applicable mainly to receivers of television broadcasting and industrial display devices.

The entire disclosure of Japanese Patent Application No. 2004-381240 filed on Dec. 28, 2005 including specification, claims, drawings and summary is incorporated herein by reference in its entirety.

What is claimed is:

1. A glass bulb for a cathode ray tube, comprising a glass panel and a glass funnel, the glass panel having an inner face forming a substantially rectangular phosphor screen, the glass funnel comprising a neck portion accommodating an electron gun, a yoke portion from a neck seal position to a yoke end, and a body portion from the yoke end to the seal edge portion; characterized in that D and H satisfy a relation 3.2≦D/H≦4.8 provided that the length of a diagonal line of the phosphor screen is D and the distance from the end of the diagonal line to the reference line of the glass funnel in the direction in parallel with bulb axis is H; the external shape of the yoke portion in cross section perpendicular to the bulb axis, at the portion of the reference line, is in a substantially rectangular shape; in a region where a height h of the body portion from the yoke end in the direction of bulb axis, satisfies 0.1H_{b}<h<0.3H_{b} provided that the height of the body portion in the direction of bulb axis is H_{b}, the external shape of the body portion in cross section perpendicular to the bulb axis is in a substantially rhombic shape and the direction of maximum diameter in the substantially rhombic shape is the same as the long axis direction of the funnel; and the minimum value of the differential value of h=f(s) is at least 0 provided that the distance from the yoke end in the direction perpendicular to the bulb axis is s.

2. The glass bulb for a cathode ray tube according to claim 1, wherein in a region where the height h satisfies 0.1H_{b}<h<0.3H_{b}, the external shape of the body portion in cross section perpendicular to the bulb axis, has a substantially rhombic shape, a coordinate (x, y) of an optional point on the profile line of the cross sectional shape, is present in a region constituted by curves represented by a formula (2×/Da)ⁿ+(2y/Di)ⁿ=1 where 1.4<n<2.0 and provided that the diameter of the external shape in the long axis is Da and the diameter in the short axis is Di.

3. A glass bulb for a cathode ray tube, comprising a glass panel and a glass funnel, the glass panel having an inner face forming a substantially rectangular phosphor screen, the glass funnel comprising a neck portion accommodating an electron gun, a yoke portion from a neck seal position to a yoke end, and a body portion from the yoke end to a seal edge portion; characterized in that D and H satisfy a relation 3.2≦D/H≦4.8 provided that the length of a diagonal line of the phosphor screen is D and the distance from the end of diagonal line to the reference line of the glass funnel in the direction in parallel with the bulb axis is H; the external shape of the yoke portion in cross section perpendicular to the bulb axis, is in a substantially rectangular shape, and in the external shape of the body portion in cross section perpendicular to the bulb axis in the region where a height h from the yoke end of the body portion in the direction of bulb axis satisfies 0.1H_{b}<h<0.3H_{b} provided that the height of the body portion in the direction of bulb axis is H_{b}, the maximum diameter portions of the external shape are present between the long axis and the respective diagonal axes, and an inwardly recessed intermediate portion between two maximum diameter portions in each short side is inwardly recessed; and the minimum value of the differential value of h=f(s) is at least 0 provided that the distance from the yoke end in the direction perpendicular to the bulb axis in the external shape is s.

4. The glass bulb for a cathode ray tube according to claim 3, wherein there is a relation d′≧d/2 provided that the distance between a point where a line connecting the two maximum diameter portions on the long axis side crosses the long axis of the glass funnel, and the bulb axis, is d, and the distance between a point where the outline of the inwardly recessed portion between the two maximum diameter portions located in each short side, crosses the long axis of the glass funnel, and the bulb axis, is d′.

5. The glass bulb for a cathode ray tube according to claim 1, wherein the differential value is at least 0.09.

6. A cathode ray tube produced by employing the glass bulb for a cathode ray tube as defined in claim 1.
